(19) United States
(12) Patent Application Publication
(10) Pub. No.: US 2004/0233323 A1
(43) Pub. Date: Nov. 25, 2004

(54) [A FlashLIGHT CONTROL DEVICE AND An OPERATING method thereof]

(76) Inventor: Jack Wang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,302

(22) Filed: Sep. 22, 2003

(30) Foreign Application Priority Data
May 20, 2003 (TW) 92113560

(51) Int. Cl. H04N 5/222

(52) U.S. Cl. 348/371

(57) ABSTRACT

A flashlight control device and an operating method thereof are provided. The present invention utilizes the light-tuning circuit to optics-electricity converse the reflected light (from the target object) to the exposure voltage. When the exposure voltage is higher than the reference voltage, the flashlight stops light-emission because it means the amount of the light-emission amount is adequate. When the exposure voltage is lower than the reference voltage, the flashlight continues to emit the incident light because the amount of the light-emission is not adequate. Hence, occurrence of the over-exposure or under-exposure problems can be effectively eliminated.

### BACKGROUND OF INVENTION

1. Field of the Invention

This invention generally relates to a digital camera, and more particularly to a flashlight control device of a digital camera and an operating method thereof.

2. Description of the Related Art

Digital camera has been widely used because of its compact size. However, if the luminance level of the operating environment is lower than the required level, conventional digital cameras have to make the flashlight perform a preliminary light-emission and a major light-emission. This may downgrade the result of the photograph.

For example, U.S. Pat. No. 6,441,856 and No. 6,359,651 disclose a digital camera making the flashlight performing a preliminary light-emission to detect the luminance level of the object by which the digital camera makes the flashlight perform a major light-emission whose amount is determined. However, these prior arts have two drawbacks. First, Performing a preliminary light-emission reduces the maximum amount of the major light-emission that the flashlight can emit. Second, the luminance level of the object may change during the time period between performing the preliminary light-emission and the major light-emission, which may cause over-exposure or under-exposure.

### SUMMARY OF INVENTION

To overcome the above drawbacks of the prior arts, the present invention provides a flashlight control device and an operating method thereof. The present invention utilizes the feature of the phototransistor which can detect the reflective rate of the target object, thereby determine the amount of light-emission of the flashlight that should emitted without a preliminary light-emission. Hence, the occurrence of over-exposure or under-exposure problems can be effectively eliminated.

The present invention provides a flashlight control device for a digital camera to control the amount of light-emission of a flashlight comprising a charger, a detector, a flashlight trigger circuit, and a light-tuning circuit. The charger includes a charger circuit and a capacitor, for receiving a charge-enabling signal from a central processor unit. The charger responsive to the charge enabling-signal charges the capacitor. The detector is coupled to the charger, for detecting the voltage of the capacitor. When the voltage of the capacitor reaches a predetermined voltage, the detector disables the charger to stop charging the capacitor, and generates a charge-complete signal to inform the central processor unit that the charging procedure is complete. The flashlight trigger circuit is coupled to the charger for receiving the voltage of the capacitor. The central processor unit, responsive to the charge-complete signal, generates a flashlight-trigger signal to enable the flashlight trigger circuit to emit an incident light to an object. The light-tuning circuit is coupled to the flashlight trigger circuit for receiving a reflected light from the object and for conversing the reflected light to an exposure voltage. When the exposure voltage is higher than a reference voltage, the light-tuning circuit disables the flashlight trigger circuit to stop emitting the incident light.

In a preferred embodiment of the present invention, the light-tuning circuit comprises a phototransistor, an integrator, a comparator circuit, and a logical gate. The phototransistor receives the reflected light and converses the reflected light to an exposure current. The integrator is coupled to the phototransistor for integrating the exposure current to output the exposure voltage. The comparator circuit is coupled to the integrator for comparing the exposure voltage and the reference voltage and outputting a comparison signal. The comparison signal is an enabled-comparison signal when the exposure voltage is higher than the reference voltage. The logical gate is coupled to the comparator circuit. The logical gate, responsive to the comparison signal and the flashlight-trigger signal, generates a flashlight-driving signal to the flashlight trigger circuit. The flashlight-driving signal, responsive to the enabled-comparison signal, disables the flashlight trigger circuit to stop emitting the incident light.

In a preferred embodiment of the present invention, the light-tuning circuit further comprises a reference voltage generating circuit, coupled to the comparator circuit, for receiving a reference signal from the central processor unit and adjusting and lowpass-filtering the reference signal to output the reference voltage; the voltage generating circuit comprises a voltage adjusting circuit, for adjusting the reference signal to output a voltage adjusting signal, and a lowpass filter, coupled to the voltage adjusting circuit, for lowpass filtering the voltage adjusting signal to output the reference voltage; the reference signal is adjusted by pulse width modulation.

In a preferred embodiment of the present invention, the light-tuning circuit further comprises a discharger circuit, coupled to the integrator, for receiving a discharger signal from the central processor unit; the integrator discharges through the discharger circuit when the discharger signal is an enabled discharger signal; the flashlight trigger circuit further comprises an Insulated Gate Bipolar Transistor for enabling or disabling the flashlight trigger circuit to emit an incident light.

The present invention also provides a method of operating a flashlight control device. This method comprises the steps of: triggering said flashlight to emit an incident light to a object; receiving a reflected light reflected from said object, and optics-electricity conversing said reflective light to an exposure voltage; and stopping emitting said incident light, responsive to said exposure voltage higher than a reference voltage.

In a preferred embodiment of the present invention, the step of receiving a reflected light and optics-electricity conversing the reflective light to an exposure voltage, further comprises the steps of conversing the reflective light to an exposure current; and integrating the exposure current to output the exposure voltage; further, the reference voltage is adjustable.

In a preferred embodiment of the present invention, the method further comprising the step of charging a capacitor to generate a charging voltage for supplying said flashlight; detecting said charging voltage; and stopping charging of said capacitor, responsive to said charging voltage reaching a predetermined voltage.

Accordingly, the present invention utilizes the light-tuning circuit to optics-electricity converse the reflected light from the target object to the exposure voltage. When the exposure voltage is lower than the reference voltage, the flashlight continues to emit the incident light because the amount of the light-emission is not enough. Hence, the present invention can determine the amount of the light-emission of the flashlight should emit without a preliminary light-emission. Hence, the occurrence of the over-exposure or the under-exposure problems can be effectively eliminated.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a block diagram of a flashlight control device in accordance to a preferred embodiment of the present invention.

FIG. 2 is a detail circuit layout of a light-tuning circuit 108 in accordance to a preferred embodiment of the present invention.

FIG. 3 is a timing diagram of the signals relating to tuning in a flashlight control device in accordance of a preferred embodiment of the present invention.

FIG. 4 is a flow chart for using a flashlight.

FIG. 5 is a flow chart for operating a flashlight control device in accordance to a preferred embodiment of the present invention.

### DETAILED DESCRIPTION

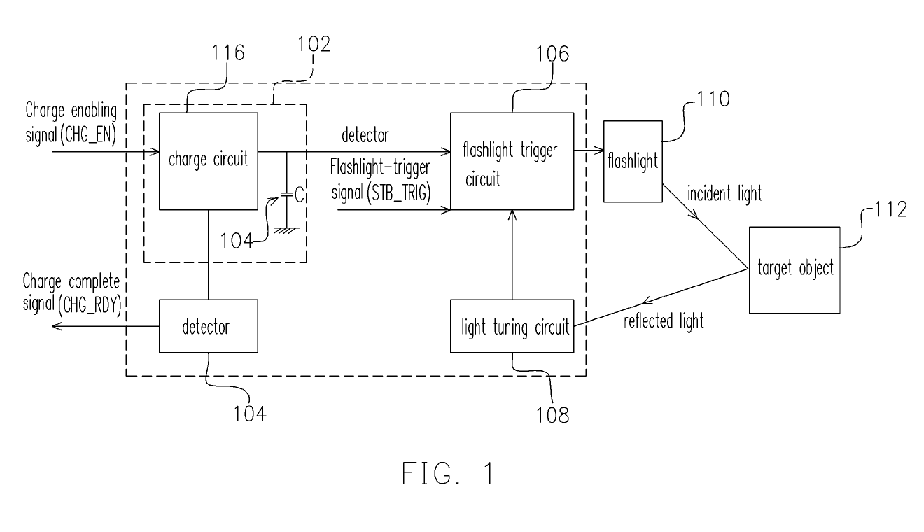

FIG. 1 is a block diagram of a flashlight control device in accordance of a preferred embodiment of the present invention. Referring to FIG. 1, a flashlight control device 10 for a digital camera to control the amount of the light-emission of a flashlight of the present invention comprises a charger 102, a detector 104, a flashlight trigger circuit 106 and a light-tuning circuit 108.

The charger 102 includes a charger circuit 116 and a capacitor 114, for receiving a charge-enabling signal CHG_EN from a central processor unit (not shown in the figures.) The charger circuit 116 charges the capacitor 114 responsive to the charge enabling-signal CHG_EN. The detector 104 is coupled to the charger 102, for detecting the voltage of the capacitor 114. When the voltage of the capacitor 114 reaches a predetermined voltage (this predetermined voltage is adjustable as needed), the detector 104 will disable the charger circuit 116 to stop charging the capacitor 114, and generate a charge-complete signal CHG_RDY to inform the central processor unit that the charging procedure is complete.

The flashlight trigger circuit 106 is coupled to the charger 102 for receiving the voltage of the capacitor. The central processor unit, responsive to the charge-complete signal CHK_RDY, generates a flashlight-trigger signal STB_TRIG to enable the flashlight trigger circuit 106 to emit an incident light to a target object 112. The flashlight trigger circuit 106 includes an Insulated Gate Bipolar Transistor (“IGBT”) for enabling or disabling the flashlight trigger circuit 106 to emit an incident light. The feature of the Insulated Gate Bipolar Transistor is its response speed and its better tolerance for larger current.

The light-tuning circuit 108 is coupled to the flashlight trigger circuit 106 for receiving a reflective light from the object 112 and for conversing the reflective light to an exposure voltage. When the exposure voltage is higher than a reference voltage, the light-tuning circuit 108 disables the flashlight trigger circuit 106 to stop emitting the incident light.

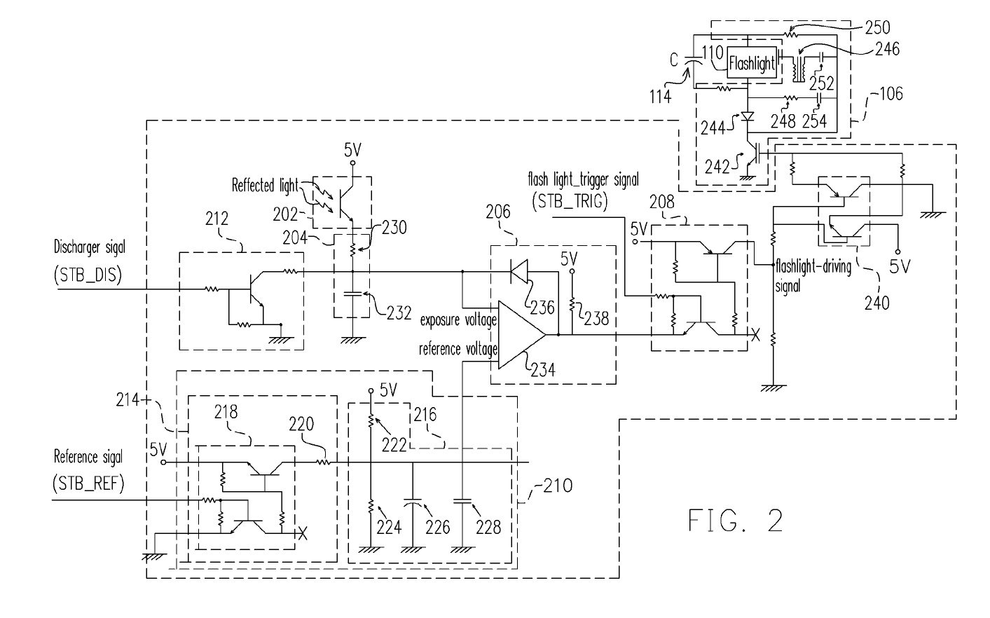

FIG. 2 is a detail circuit layout of light-tuning circuit 108 in accordance to a preferred embodiment of the present invention. The light-tuning circuit 108 comprises a phototransistor 202, an integrator 204, a comparator circuit 206, a logical gate 208, a reference voltage generating circuit 210 and a discharger circuit 212.

The reference voltage generating circuit 210 receives a reference signal STB_REF from the central processor unit, and adjust and lowpass-filter the reference signal to output the reference voltage. The voltage generating circuit 210 comprises a voltage adjusting circuit 214 and a low-pass filter 216. The reference voltage adjusting circuit 214 includes a logic gate 218 and a resister 220 to voltage-adjust the reference signal STB_REF to output the voltage-adjusted signal. The lowpass filter 216 includes a resistor 222, a resistor 224, a capacitor 226, and a capacitor 228 to lowpass filter the voltage-adjusted signal and then outputs a DC reference voltage. In a preferred embodiment of the present invention, the reference signal STB_REF is adjusted by pulse width modulation (“PWM”).

The phototransistor 202 receives the reflected light from the object 112 and optics-electricity converses the reflected light to an exposure current.

The integrator 204 includes a resistor 230 and a capacitor 232 for integrating the exposure current to output the exposure voltage.

The comparator circuit 206 includes a comparator 234, a diode 236, and a resister 238. The comparator circuit 206 compares the exposure voltage and the reference voltage and outputting a comparison signal. The comparison signal is an enabled-comparison signal (e.g., high voltage level) when the exposure voltage is higher than the reference voltage. The comparison signal is a disabled-comparison signal (e.g., low voltage level) when the exposure voltage is lower than the reference voltage.

The logical gate 208 receives and makes a NOR operation of comparison signal and the flashlight-trigger signal STB_TRIG. Then the logical gate 208 generates a flashlight-driving signal to the flashlight trigger circuit 106 to control the operation of the flashlight trigger circuit 106. The logical gate 208 is deemed be a NOR gate. When the flashlight-trigger signal STB_TRIG is in high voltage level and the comparison signal is in low voltage level, the flashlight-driving signal is in high voltage level and will enable the flashlight trigger circuit 106, which makes the flashlight emits an incident light to the object 112. When the comparison signal is in low voltage level, the flashlight-driving signal becomes in low voltage level and will disable the flashlight trigger circuit 106, which makes the flashlight stop emitting an incident light to the object 112. Furthermore, to increase the driving ability and the switch speed, the flashlight-driving signal is transmitted via a driver circuit 240 to the flashlight trigger circuit 106.

The discharger circuit 212 is for receiving a discharger signal STB_DIS from the central processor unit. The integrator 204 discharges through the discharger circuit 212 when the discharger signal STB_DIS is an enabled discharger signalFurthermore, the flashlight trigger circuit 106 comprises an IGBT 242, a diode 244, a trigger coil 246, a resister 248, a resister 250, a capacitor 252, and a capacitor 254. When the flashlight-trigger signal STB_TRIG is in high voltage level, the flashlight-driving signal on the base of IGBT 242 is in low voltage level thereby turn off the IGBT 242 (i.e., the flashlight trigger circuit 106 is disabled) and make the flashlight stop light-emission.

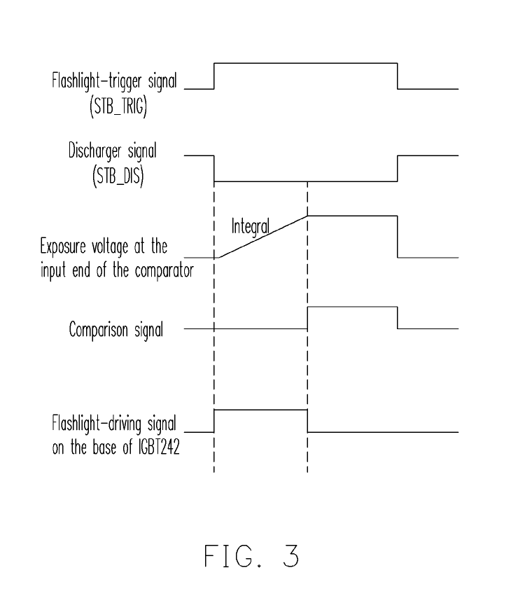

FIG. 3 is a timing diagram of the signals relating to tuning in a flashlight control device in accordance to a preferred embodiment of the present invention. When the central processor unit enables the flashlight-trigger signal STB_TRIG to a high voltage level, the discharger signal STB_DIS will be disabled to a lower voltage level. After the flashlight-trigger signal STB_TRIG is enabled, the IGBT 242 will be turned on to make flashlight emit light-emission to the object 112. Then the phototransistor 202 receives the reflected light from the object 112 and optics-electricity converses the reflective light to output an expose current. The integrator 204 then integrates the exposure current to output an exposure voltage. When the exposure voltage is higher than the reference voltage, the comparison signal will switch from the low voltage to the high voltage level. Then, the IGBT 242 will be turned off (i.e., the flashlight trigger circuit 106 is disabled) to make the flashlight stop light-emission.

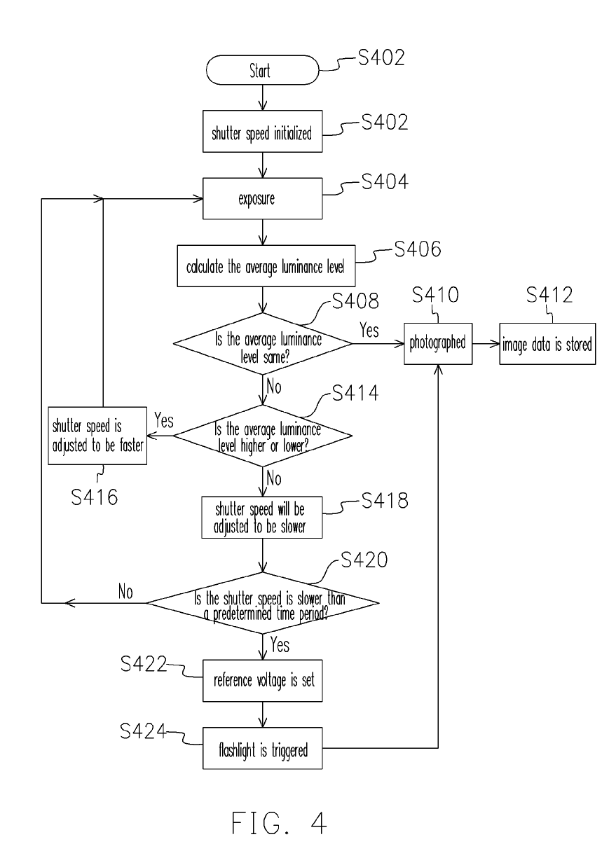

FIG. 4 is a flow chart for using a flashlight. When using a digital camera to take a photograph, the shutter speed will be initialized (S402). Then an exposure is done (S404) to calculate the average luminance level (S406). Then the average luminance level will be compared with the reference luminance level to determine whether they are same (S408). If so, the photograph will be taken (S410) and the image data will be stored (S412). If not, the average luminance level will be compared with the reference luminance level to determine whether the average luminance level is higher or lower (S414). If higher, the shutter speed will be adjusted to be faster (S416). Then the procedure goes back to S404. If lower, the shutter speed will be adjusted to be slower (S416). Then the shutter speed further needs to be determined to see whether it is slower than a predetermined time period (e.g., 1/30 second)(S420). If not, it means that there is no need for using the flashlight and the procedure goes back to S404. If so, it means that the environment is too dark and flashlight is required. Then the reference voltage will be set (S422) and the flashlight will be triggered (S424) to take the photograph (S412).

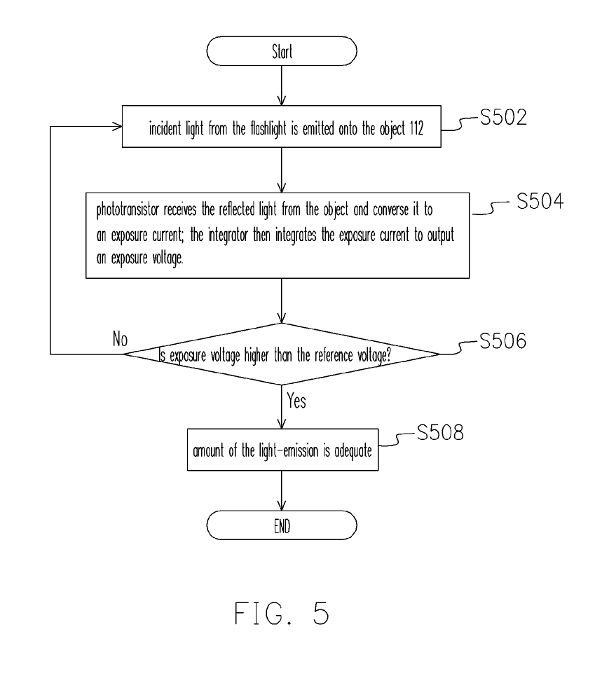

FIG. 5 is a flow chart for operating a flashlight control device in accordance to a preferred embodiment of the present invention. Referring to FIGS. 1, 2, and 5, the flashlight control device 10 first charges the capacitor 114 via the charger circuit 116 to supply the flashlight 110. When detecting that the voltage of the capacitor 114 reaches a predetermined voltage, the flashlight control device makes the charger circuit 116 stop charging the capacitor 114 and triggers the flashlight 110 to emit an incident light to the object 112 (S502). Then the phototransistor 220 receives the reflected light from the object 112 and converse it to an exposure current; the integrator 204 then integrates the exposure current to output an exposure voltage (S504). When the exposure voltage is higher than the reference voltage, the flashlight stops light-emission because it means the amount of the light-emission adequate (S508). When the exposure voltage is lower than the reference voltage, the flashlight continues to emit the incident light because it means the amount of the light-emission is not adequate, and the procedure goes back to S502 to make the flashlight continue to emit the incident light.

Hence, the present invention utilizes the light-tuning circuit to optics-electricity converse the reflective light (from the target object) to the exposure voltage. When the exposure voltage is higher than the reference voltage, the flashlight stops light-emission because it means the amount of the light-emission is adequate. When the exposure voltage is lower than the reference voltage, the flashlight continues to emit the incident light because the amount of the light-emission is adequate. Hence, the present invention can determine the amount of the light-emission the flashlight should emit without a preliminary light-emission. Hence, the occurrence of the over-exposure or the under-exposure problems can be effectively eliminated.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A flashlight control device, for a digital camera, to control an amount of a light-emission of a flashlight, comprising:
a charger, including a charger circuit and a capacitor for receiving a charge-enabling signal from a central processor unit, wherein said charger responsive to said charge enabling-signal charges said capacitor;
a detector, coupled to said charger, for detecting a voltage of said capacitor, when the voltage of said capacitor reaches a predetermined voltage, said detector disabling said charger to stop charging said capacitor and said detector generating a charge-complete signal to inform said central processor unit;
a flashlight trigger circuit, coupled to said charger, for receiving a voltage of said capacitor, wherein said central processor unit responsive to said charge-complete signal generates a flashlight-trigger signal to enable said flashlight trigger circuit to emit an incident light to an object; and
a light-tuning circuit, coupled to said flashlight trigger circuit, for receiving a reflected light from said object and conversing said reflected light to a exposure voltage, when said exposure voltage is higher than a reference voltage, said light-tuning circuit disabling said flashlight trigger circuit to stop emitting said incident light.

2. The flashlight control device of claim 1, said light-tuning circuit further comprising:
a phototransistor for receiving said reflected light and conversing said reflected light to an exposure current; an integrator, coupled to said phototransistor, for integrating said exposure current to output said exposure voltage;
a comparator circuit, coupled to said integrator, for comparing said exposure voltage and said reference voltage and outputting a comparison signal, said comparison signal being an enabled-comparison signal when said exposure voltage is higher than said reference voltage; and
a logical gate, coupled to said comparator circuit, responsive to said comparison signal and said flashlight-trigger signal generating a flashlight-driving signal to said flashlight trigger circuit, said flashlight-driving signal, responsive to said enabled-comparison signal, disabling said flashlight trigger circuit to stop emitting said incident light.

3. The flashlight control device of claim 2, wherein said logic gate is a NOR gate.

4. The flashlight control device of claim 2, where in said light-tuning circuit further comprises a voltage generating circuit, coupled to said comparator circuit, for receiving a reference signal from said central processor unit and adjusting and lowpass-filtering said reference signal to output said reference voltage.

5. The flashlight control device of claim 4, said voltage generating circuit further comprising:
a voltage adjusting circuit, for adjusting said reference signal to output a voltage adjusting signal; and
a lowpass filter, coupled to said voltage adjusting circuit, for lowpass filtering said voltage adjusting signal to output said reference voltage.

6. The flashlight control device of claim 4, wherein said reference signal is adjusted by a pulse width modulation.

7. The flashlight control device of claim 2, wherein said light-tuning circuit further comprises a discharger circuit, coupled to said integrator, for receiving a discharger signal from said central processor unit, said integrator discharging through said discharger circuit when said discharger signal is an enabled discharger signal.

8. The flashlight control device of claim 1, wherein said flashlight trigger circuit further comprises an Insulated Gate Bipolar Transistor for enabling or disabling said flashlight trigger circuit to emit an incident light.

9. A method of operating a flashlight control device, for a digital camera using a flashlight, comprising the steps of:
triggering said flashlight to emit an incident light to an object;
receiving a reflected light reflected from said object, and optics-electricity conversing said reflected light to an exposure voltage; and
stopping emitting said incident light, responsive to said exposure voltage higher than a reference voltage.

10. The method of operating a flashlight control device 9, said step of receiving a reflected light and optics-electricity conversing said reflective light to an exposure voltage, further comprising:
conversing said reflected light to an exposure current; and
integrating said exposure current to output said exposure voltage.

11. The method of operating a flashlight control device 9, wherein said reference voltage is adjustable.

12. The method of operating a flashlight control device 9, further comprising the step of charging a capacitor to generate a charging voltage for supplying said flashlight.

13. The method of operating a flashlight control device 12, further comprising the steps of:
detecting said charging voltage; and
stopping charging said capacitor, responsive to said charging voltage reaching a predetermined voltage.
